(19) United States
(12) Patent Application Publication
(10) Pub. No.: US 2023/0393578 A1
(43) Pub. Date: Dec. 7, 2023

(54) AUTONOMOUS WORKING DEVICE, AND CONTROL METHOD THEREFOR

(71) Applicant: Positec Power Tools (SUZHOU) Co., Ltd., Suzhou (CN)

(72) Inventor: Emanuel CONTI, Suzhou (CN)

(21) Appl. No.: 18/205,454

(22) Filed: Jun. 2, 2023

Related U.S. Application Data
(63) Continuation of application No. PCT/CN2021/135333, filed on Dec. 3, 2021.

(30) Foreign Application Priority Data
Dec. 3, 2020 (CN) 202011393775.1

(51) Int. Cl. G05D 1/02

(52) U.S. Cl. CPC G05D 1/0214; G05D 1/0255; G05D 1/024; G05D 1/0278; G05D 1/0274

(57) ABSTRACT

This application relates to an autonomous working apparatus and a control method for an autonomous working apparatus. The autonomous working apparatus includes: a mover, configured to drive the autonomous working apparatus to move in a working area; a sensor, including at least a first sensor and a second sensor different from the first sensor, the first sensor being configured to obtain surrounding environment data of the autonomous working apparatus, and the second sensor being configured to obtain the surrounding environment data of the autonomous working apparatus or positioning data of a current position of the autonomous working apparatus; and a processor, connected at least to the sensor, the processor being configured to determine a category of an area in a direction of travel of the autonomous working apparatus based on a processing result of data input by the second sensor and to generate at least one instruction associated with the first sensor according to the category.

### CROSS-REFERENCE TO RELATED APPLICATION

This application is a National Stage Application of International Application No. PCT/CN2021/135333, filed on Dec. 3, 2021, which claims benefit of and priority to Chinese Patent Application No. 202011393775.1, filed on Dec. 3, 2020, all of which are hereby incorporated by reference in their entirety for all purposes as if fully set forth herein.

### TECHNICAL FIELD

This application relates to an autonomous working apparatus and a control method for an autonomous working apparatus, and belongs to the technical field of automatic control.

### BACKGROUND

At present, an autonomous working apparatus with an automatic moving function is widely used as, for example, an intelligent mower, a sweeping robot, or the like. In order to make the autonomous working apparatus capable of avoiding obstacles automatically, the autonomous working apparatus is usually provided with an ultrasonic sensor for detecting the obstacles.

### SUMMARY

This application provides an autonomous working apparatus and a control method for an autonomous working apparatus, which may solve the problem that when a sensor mistakenly detects a preset area as an obstacle, the autonomous working apparatus cannot move to the preset area. This application provides the following technical solution.

According to a first aspect, an autonomous working apparatus is provided, including:
a mover, configured to drive the autonomous working apparatus to move in a working area;
a sensor, including at least a first sensor and a second sensor different from the first sensor, the first sensor being configured to obtain surrounding environment data of the autonomous working apparatus, and the second sensor being configured to obtain the surrounding environment data of the autonomous working apparatus or positioning data of a current position of the autonomous working apparatus; and
a processor, connected at least to the sensor, the processor being configured to determine a category of an area in a direction of travel of the autonomous working apparatus based on a processing result of data input by the second sensor and to generate at least one instruction associated with the first sensor according to the category.

Optionally, the category of the area includes a first area having a gradient within a preset range. The processor is configured to generate an instruction for reducing a detection distance of the first sensor when determining that the area in the direction of travel of the autonomous working apparatus is the first area.

Optionally, the category of the area includes a first area having a gradient within a preset range. The processor is configured to generate an instruction for turning off the first sensor when determining that the area in the direction of travel of the autonomous working apparatus is the first area.

Optionally, the category of the area includes a first area having a gradient within a preset range. The processor is configured to generate an instruction for filtering the surrounding environment data of the autonomous working apparatus obtained by the first sensor when determining that the area in the direction of travel of the autonomous working apparatus is the first area.

Optionally, the second sensor is configured to obtain the surrounding environment data of the autonomous working apparatus. The processor is further configured to determine whether an obstacle surrounds the autonomous working apparatus based on fusion of data input by the first sensor and the second sensor. The category of the area includes a first area having a gradient within a preset range. The processor is configured to generate an instruction for reducing a fusion ratio of the surrounding environment data of the autonomous working apparatus obtained by the first sensor when determining that the area in the direction of travel of the autonomous working apparatus is the first area.

Optionally, the second sensor includes at least one of a LIDAR sensor and a vision sensor.

Optionally, the second sensor is configured to obtain positioning data of a current position of the autonomous working apparatus. The positioning data includes height data of the current position of the autonomous working apparatus. The processor is configured to calibrate a position of a first area having a gradient within a preset range in the working area according to the height data of the surface of the working area before the autonomous working apparatus executes a working task.

Optionally, the processor is further configured to determine whether a distance between the autonomous working apparatus and the first area in the direction of travel is less than or equal to a preset distance, and to generate the at least one instruction if the distance is less than or equal to the preset distance.

Optionally, the second sensor includes a satellite positioning sensor.

Optionally, the first sensor includes an ultrasonic sensor.

Optionally, a detection distance of the ultrasonic sensor is less than or equal to 60 cm.

Optionally, a detection distance of the ultrasonic sensor is less than or equal to 38 cm.

According to a second aspect, a control method for an autonomous working apparatus is provided. The autonomous working apparatus includes a mover, a sensor, and a processor connected at least to the sensor. The sensor includes at least a first sensor and a second sensor different from the first sensor. The control method is applied to the processor. The control method includes:
controlling the first sensor to obtain surrounding environment data of the autonomous working apparatus;
controlling the second sensor to obtain the surrounding environment data of the autonomous working apparatus or positioning data of a current position of the autonomous working apparatus;
determining a category of an area in a direction of travel of the autonomous working apparatus according to a processing result of data input by the second sensor; and
generating at least one instruction associated with the first sensor according to the category.

According to a third aspect, a processor is provided. The processor includes at least one processor and a storage medium. The memory stores a program loaded and executed by the at least one processor to implement the steps of the control method for the autonomous working apparatus provided according to the second aspect.

According to a fourth aspect, a computer-readable storage medium is provided. The storage medium stores a computer program. The computer program, when executed by a processor, implements the steps of the control method for the autonomous working apparatus provided according to the second aspect.

This application has the following beneficial effects. A category of an area in a direction of travel of an autonomous working apparatus is determined based on data of a second sensor, and a processor generates a instruction associated with a first sensor according to the category. The problem that the first sensor (such as an ultrasonic sensor) executes an obstacle avoidance action upon mistaken detection of a slope as an obstacle and thus cannot move forward up the slope may be at least solved. Therefore, the autonomous working apparatus of this application may normally execute the obstacle avoidance action without affecting a climbing function and a mowing task of the autonomous working apparatus.

The above description is only an overview of the technical solution of this application. In order that the technical means of this application is understandable more clearly and implementable according to the contents of the specification, preferred embodiments of this application are described in detail below with the accompanying drawings.

### BRIEF DESCRIPTION OF THE DRAWINGS

FIG. 1 is a schematic structural diagram of an autonomous working apparatus according to an embodiment of this application.

FIG. 2 is a schematic module connection diagram of an autonomous working apparatus according to an embodiment of this application.

FIG. 3 is a flowchart of a control method for an autonomous working apparatus according to an embodiment of this application.

FIG. 4 is a block diagram of a processor of an autonomous working apparatus according to an embodiment of this application.

### DETAILED DESCRIPTION

Specific implementations of this application are described in further detail in the following with reference to the accompanying drawings and embodiments. The following embodiments are used to illustrate this application and not to limit the scope of this application.

First, several terms described in this application are introduced.

Real-time kinematic (RTK) carrier phase differential technology is an RTK positioning technology based on a carrier phase observation value, which provides a three-dimensional positioning result of a station in a specified coordinate system in real time and achieve centimeter-level accuracy.

The working principle of RTK includes that a reference station transmits position information and current coordinate information obtained from a positioning satellite to a mobile station. The mobile station receives the position information from the reference station and the position information from the positioning satellite, composes a differential observation value in the system for real-time processing, and also provides a centimeter-level positioning result.

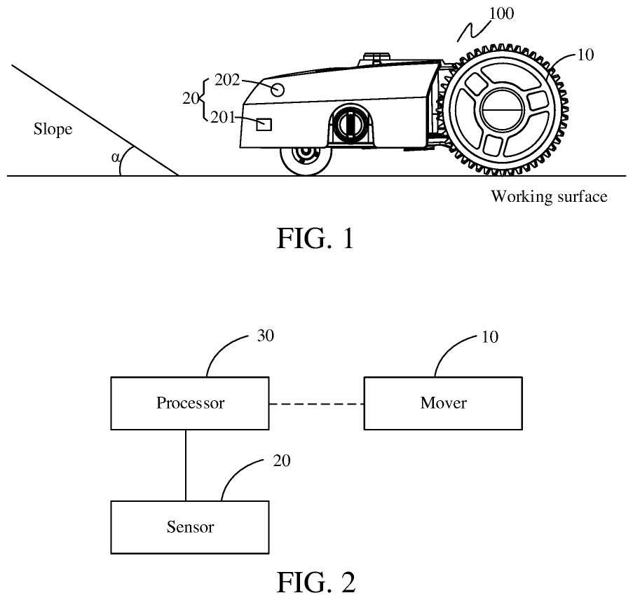

FIG. 1 is a schematic structural diagram of an autonomous working apparatus 100 according to an embodiment of this application. The autonomous working apparatus 100 is an intelligent mower, a sweeping robot, a mopping robot, or another device with an automatic moving function. This embodiment describes the autonomous working apparatus as an intelligent mower without limiting a device type of the autonomous working apparatus. As shown in FIG. 1 and FIG. 2, the autonomous working apparatus 100 includes at least: a mover a sensor 20, and a processor 30. The processor 30 is connected at least to the sensor 20.

The mover 10 is configured to drive the autonomous working apparatus 100 to move in a working area. In one example, the mover 10 includes a drive assembly and a moving mechanism in transmission connection with the drive assembly. The drive assembly is a generator, a motor, or the like. The moving mechanism is a wheel body. This embodiment is not limited to the implementations of the drive assembly and the moving mechanism. Optionally, as shown in FIG. 2, the processor 30 is further connected to the mover 10, so as to control the mover 10 to drive the autonomous working apparatus to move in the working area.

The sensor 20 includes at least a first sensor 201 and a second sensor 202 different from the first sensor 201. The first sensor 201 is configured to obtain surrounding environment data of the autonomous working apparatus 100. The second sensor 202 is configured to obtain the surrounding environment data of the autonomous working apparatus 100 or positioning data of a current position of the autonomous working apparatus. Optionally, the first sensor 201 is configured to transmit a signal (such as an ultrasonic signal or an optical signal) around the autonomous working apparatus 100 and receive a reflected signal of the signal, so as to obtain surrounding environment data of the autonomous working apparatus 100. A signal transmitting direction includes a direction of travel of the autonomous working apparatus 100. Optionally, the second sensor 202 obtains the surrounding environment data of the autonomous working apparatus in different manners (such as image sensing) or current positioning data of the autonomous working apparatus in a manner such as satellite positioning.

Optionally, the first sensor 201 is an ultrasonic sensor. At this moment, the signal is an ultrasonic signal. Alternatively, the first sensor 201 is an infrared sensor. At this moment, the signal is an infrared signal. Optionally, the second sensor 202 is a satellite positioning sensor which is configured to obtain latitude and longitude data and height data of the autonomous working apparatus.

Since the first sensor 201 detects environment data by transmitting and receiving signals, it is likely to perform an obstacle avoidance operation by misjudging that there are obstacles around when there are slopes or high-density grass around or when the apparatus falls into a pit, which leads to the inability to normally execute working tasks in slope or high-density grass areas or makes it difficult for the apparatus to get out of trouble.

Therefore, this application is improved in that the processor 30 determines a category of an area in a direction of travel of the autonomous working apparatus 100 based on a processing result of data input by the second sensor 202 and generates at least one instruction associated with the first sensor 201 according to the category. Optionally, the area in the direction of travel of the autonomous working apparatus 100 is an area at which the autonomous working apparatus 100 will arrive after the current moment. Optionally, the direction of travel of the autonomous working apparatus is determined by the processor 30 according to an operating state of the mover. For example, the direction of travel is determined according to a direction of a wheel. Alternatively, the direction of travel is determined according to a sensing assembly such as a gyroscope in the autonomous working apparatus. This embodiment is not limited to the manner of determining the direction of travel.

The autonomous working apparatus 100 of this embodiment determines a category of an area in the direction of travel of the autonomous working apparatus 100 based on data of the second sensor 202, and the processor 30 generates a instruction associated with the first sensor 201 according to the category. For example, when it is determined that the area in the direction of travel of the autonomous working apparatus 100 is a slope, at least one instruction associated with the first sensor 201 is generated to interfere with the detection of the first sensor 201 or environment data detected by the first sensor, thereby reducing the dependence of the autonomous working apparatus 100 on the first sensor 201 when identifying obstacles, and solving the misjudgment problem in the foregoing scenarios. When it is determined that the area in the direction of travel of the autonomous working apparatus 100 is a high-density grass area, the misjudgment problem is solved in the same manner to ensure the normal working of the autonomous working apparatus 100.

Therefore, the autonomous working apparatus 100 of this application solves at least the problem that the first sensor (such as an ultrasonic sensor) executes an obstacle avoidance action upon mistaken detection of a slope and high-density grass as an obstacle and thus cannot move forward up the slope. In other words, the autonomous working apparatus 100 of this application normally executs the obstacle avoidance action without affecting a climbing function and a mowing task of the autonomous working apparatus 100.

In an implementation, the category of the area includes a first area having a gradient within a preset range. The processor 30 is configured to generate an instruction for reducing a detection distance of the first sensor 201 when determining that the area in the direction of travel of the autonomous working apparatus 100 is the first area.

For example, as shown in FIG. 1, the first area represents an uphill area in which a gradient (namely, a) is greater than a gradient threshold. A mounting height of the sensor 20 is greater than the height of the ground where the autonomous working apparatus is located. Therefore, when the gradient of the uphill area is small, the uphill area is not mistakenly detected as an obstacle. When the gradient of the uphill area is large, the uphill area will be mistakenly detected as an obstacle. Based on this, the gradient threshold is a critical gradient that causes the sensor 20 to mistakenly detect the uphill area as an obstacle. Optional, the critical gradient is 20 degrees, 25 degrees, 30 degrees, or 35 degrees, which specifically is set according to actual situations. In addition, an area with a large slope is identified as an obstacle boundary, such as an area with a slope greater than 70 degrees. To sum up, optionally, the gradient range is 20-70 degrees. Optionally, the gradient range is 25-60 degrees. Optionally, the gradient range is 25-55 degrees.

In this embodiment, when the area in the direction of travel of the autonomous working apparatus 100 is determined as the first area, the detection capability of the first sensor 201 is reduced by reducing the detection distance of the first sensor 201, thereby avoiding misjudging the first area as an obstacle. In addition, after the autonomous working apparatus 100 leaves the first area for a predetermined distance or a predetermined time, the processor is further configured to stop generating an instruction for reducing the detection distance of the first sensor 201, so as to restore the normal detection capability of the first sensor 201. Therefore, the autonomous working apparatus 100 successfully avoids obstacles without affecting the climbing function of the autonomous working apparatus.

In an implementation, the processor 30 is configured to generate an instruction for turning off the first sensor 201 when determining that the area in the direction of travel of the autonomous working apparatus 100 is the foregoing first area. By turning off the first sensor 201, it is possible to avoid the first area being misjudged as an obstacle to the greatest extent. In addition, after the autonomous working apparatus 100 leaves the first area for the predetermined distance or the predetermined time, the processor 30 is further configured to stop generating an instruction for turning off the first sensor 201, so as to restore the normal detection capability of the first sensor 201. Therefore, the autonomous working apparatus 100 successfully avoids obstacles without affecting the climbing function of the autonomous working apparatus.

In an implementation, the processor 30 is configured to generate an instruction for filtering the surrounding environment data of the autonomous working apparatus 100 obtained by the first sensor 201 when determining that the area in the direction of travel of the autonomous working apparatus 100 is the foregoing first area. By filtering the surrounding environment data of the autonomous working apparatus 100 obtained by the first sensor 201, it is possible to avoid processing the data of the first sensor 201, thereby avoiding misjudging the first area as an obstacle as much as possible. In addition, after the autonomous working apparatus 100 leaves the first area for the predetermined distance or the predetermined time, the processor 30 is further configured to stop generating an instruction for filtering the surrounding environment data of the autonomous working apparatus 100 obtained by the first sensor 201, so as to restore the normal data processing of the first sensor 201. Therefore, the autonomous working apparatus 100 successfully avoids obstacles without affecting the climbing function of the autonomous working apparatus.

In an implementation, the second sensor 202 is configured to obtain the surrounding environment data of the autonomous working apparatus 100. The processor 30 is further configured to determine whether an obstacle surrounds the autonomous working apparatus 100 based on fusion of data input by the first sensor 201 and the second sensor 202. The processor 30 is configured to generate an instruction for reducing a fusion ratio of the surrounding environment data of the autonomous working apparatus obtained by the first sensor 201 when determining that the area in the direction of travel of the autonomous working apparatus 100 is the first area. By reducing the fusion ratio of the surrounding environment data of the autonomous working apparatus obtained by the first sensor 201, the possibility of misjudgment of the autonomous working apparatus 100 is reduced when the autonomous working apparatus 100 travels to the first area, and the obstacle identification capability of the autonomous working apparatus 100 is ensured. In addition, after the autonomous working apparatus 100 leaves the first area for a predetermined distance or a predetermined time, the processor 30 is further configured to stop generating an instruction for reducing the fusion ratio of the surrounding environment data of the autonomous working apparatus obtained by the first sensor 201, so as to restore the normal data processing of the first sensor 201. Therefore, the autonomous working apparatus 100 successfully avoids obstacles without affecting the climbing function of the autonomous working apparatus.

In an implementation, the processor 30 is further configured to determine whether there is an obstacle surrounding the autonomous working apparatus 100 based on the data input by the first sensor 201; if the processor 30 determines that there is an obstacle surrounding the autonomous working apparatus 100, the processor 30 is further configured to control the autonomous working apparatus 100 to execute an obstacle avoidance action when the distance between the autonomous working apparatus 100 and the obstacle is less than or equal to the reaction distance. The processor 30 is further configured to generate an instruction for reducing the reaction distance when it determines that the area in the direction of travel of the autonomous working apparatus 100 is the first area. By reducing the reaction distance, the ability of the autonomous working apparatus 100 to respond to the detection result of the first sensor 201 is reduced, so as to avoid prematurely executing an obstacle avoidance action after misjudging the first area as an obstacle. In addition, after the autonomous working apparatus 100 leaves the first area for a predetermined distance or for a predetermined time, the processor 30 may further be configured to stop generating the instruction for reducing the reaction distance, so as to restore the normal reaction capability of the autonomous working apparatus 100 to react to the first sensor 201's detection results. In this way, the autonomous working apparatus 100 can successfully avoid obstacles without affecting the climbing function of the autonomous working apparatus.

Specifically, at least two response distances are stored in the processor 30.

When the processor 30 determines that the area in the direction of travel of the autonomous working apparatus 100 is not the first area and there are obstacles around the autonomous working apparatus 100, then when the processor 30 detects that the distance between the obstacles and the autonomous working apparatus 100 is less than or equal to a first reaction distance, the processor 30 controls the autonomous working apparatus 100 to execute an obstacle avoidance action. The obstacle avoidance action includes, but is not limited to, pausing its movement, turning or stepping back.

When the processor 30 determines that the area in the direction of travel of the autonomous working apparatus 100 is the first area and there are obstacles around the autonomous working apparatus 100, then when the processor 30 detects that the distance between the obstacles and the autonomous working apparatus 100 is less than or equal to a second reaction distance, the processor 30 controls the autonomous working apparatus 100 to execute an obstacle avoidance action.

The second reaction distance is smaller than the first reaction distance.

In this way, compared with the autonomous working apparatus 100 executing the obstacle avoidance action at a relatively large first reaction distance from regular obstacles, the autonomous working apparatus 100 can only execute the obstacle avoidance action at a relatively small second reaction distance from the first area. Reducing the reaction distance will neither affect the successful avoidance of regular obstacles by the autonomous working apparatus 100, but also enable the autonomous working apparatus 100 to preliminarily judge that there is a first area in the direction of travel, and when the first area is mistakenly detected as an obstacle, it can move to a position closer to the first area, as the autonomous working apparatus 100 gets closer to the first area, the front side of the autonomous working apparatus 100 slowly tilts up with the surface slope of the first area, then the data detected by the first sensor 201 will change, the autonomous working apparatus 100 will not continue to misidentify the first area as an obstacle, and the autonomous working apparatus 100 will have the opportunity to correct the previous misidentification of the first area as an obstacle, it can climb normally without affecting the climbing function of the autonomous working apparatus 100.

In an implementation, the category of the area includes a second area having a grass height within a preset height range. When the processor 30 determines that the area in the direction of travel of the autonomous working apparatus 100 is the second area, an instruction for reducing a detection distance of the first sensor 201 is generated; or, an instruction for turning off the first sensor 201 is generated; or, an instruction for filtering the surrounding environment data of the autonomous working apparatus 100 obtained by the first sensor 201 is generated; or, an instruction for reducing the fusion ratio of the surrounding environment data of the autonomous working apparatus obtained by the first sensor 201 is generated. In this way, the high-density grass area is avoided from being misjudged as an obstacle, thereby effectively cutting the high-density grass area.

In an implementation, the second sensor 202 includes at least one of a LIDAR sensor and a vision sensor. Through the data returned by the sensors, obstacles, slopes, high-density grass, and other areas is identified more accurately, thereby ensuring the normal operation of working tasks.

In an implementation, the second sensor 202 is configured to obtain positioning data of a current position of the autonomous working apparatus 100. The positioning data includes height data of the current position of the autonomous working apparatus 100. The processor is configured to calibrate a position of a first area having a gradient within a preset range in the working area according to the height data of the surface of the working area before the autonomous working apparatus 100 executes a working task.

Optionally, the second sensor 202 includes a satellite positioning sensor. The satellite positioning sensor is configured to obtain the positioning data of the current position of the autonomous working apparatus in real time. Optionally, the satellite positioning sensor is an assembly for positioning based on RTK technology. The satellite positioning sensor is, certainly, also an assembly for positioning based on other technologies (such as, GPS). This embodiment is not limited to the type of the satellite positioning sensor.

Specifically, before executing a working task, the processor 30 controls the operation of the mover 10, and collects the positioning data of the current position of the autonomous working apparatus (including the height data of the current position) in real time according to the satellite positioning sensor during the movement, thereby drawing an area map of the working area. If the height of the area increases continuously and the increasing value is greater than a preset value every time, the slope of the area is considered as exceeding a slope threshold, and the area is the foregoing first area. The processor 30 compares height data at various positions in the working area to calibrate all first areas in the working area.

Certainly, position information of the first area also is obtained in other manners. For example, position information of the first area transmitted by another device is received. Or, position information of the first area input by a user is received. Or, position information of the first area stored in advance is read. Certainly, the manner of obtaining the position information of the first area is another manner. This embodiment is not limited to the manner of obtaining the position information of the first area.

In another implementation, each first area corresponds to one area identifier. At this moment, the processor 30 determines whether the area in the direction of travel of the autonomous working apparatus is the first area through a detection result of the area identifier. Certainly, other second areas (high-density grass areas) and third areas (pit areas) is also identified by the foregoing area identifier. Only the first area is illustrated here.

Optionally, the area identifier is spaced from the first area by a certain distance to ensure that the autonomous working apparatus 100 determines, through the area identifier, the type of an area at which the apparatus will arrive before arriving at the first area. At this moment, the autonomous working apparatus 100 is provided with an identifier detection assembly. The identifier detection assembly is configured to detect the area identifier. The processor 30 receives detection data of the identifier detection assembly and determines whether the area in the direction of travel is the first area according to a detection result of the identifier detection assembly. Optionally, the area identifier is a graphic identifier (such as, a two-dimensional barcode, or a bar label). Correspondingly, the identifier detection assembly is a camera, a scanner, or the like. This embodiment is not limited to the implementation of the area identifier and the implementation of the identifier detection assembly.

In an implementation, the processor 30 is further configured to determine whether a distance between the autonomous working apparatus 100 and the first area in the direction of travel is less than or equal to a preset distance. If yes, the at least one instruction associated with the first sensor 201 is generated. Optionally, the preset distance is pre-stored in the autonomous working apparatus, and is set to 2 m, 1 m, or the like. Optionally, the distance between the current position and the first area refers to a linear distance between the current position and the first area in the direction of travel.

In an implementation, the first sensor includes at least one of an ultrasonic sensor and a millimeter-wave radar. The sensor quickly detects objects around the autonomous working apparatus 100. Optionally, the detection distance of the ultrasonic sensor is less than or equal to 60 cm. For example, the detection distance is 40 cm, 45 cm, 50 cm, 55 cm, or 60 cm. Optionally, the detection distance of the ultrasonic sensor is less than or equal to 38 cm. For example, the detection distance is 10 cm, 20 cm, 30 cm, 35 cm, or 38 cm. If the detection distance of the ultrasonic sensor is too large, it is prone to misjudgment. If the detection distance is too small, it is not conducive to detecting objects around the autonomous working apparatus 100.

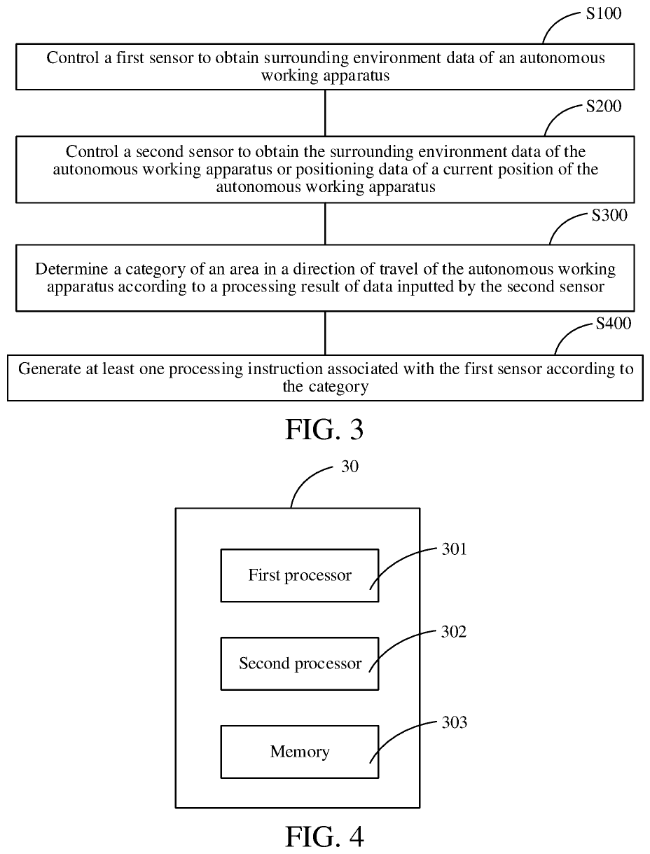

FIG. 3 is a flowchart of a control method for an autonomous working apparatus according to an embodiment of this application. This embodiment will be exemplified by the method being applied to the autonomous working apparatus 100 shown in FIG. 1 and the execution entity of each step being the processor 30 in the system. The method includes at least the following steps:

S100: Control the first sensor 201 to obtain surrounding environment data of the autonomous working apparatus.

Optionally, the first sensor 201 includes an ultrasonic sensor, a millimeter-wave radar, and the like.

S200: Control the second sensor 202 to obtain the surrounding environment data of the autonomous working apparatus 100 or positioning data of a current position of the autonomous working apparatus 100.

Optionally, the second sensor 202 includes a LIDAR sensor, a vision sensor, a satellite positioning sensor, and the like.

S300: Determine a category of an area in a direction of travel of the autonomous working apparatus 100 according to a processing result of data input by the second sensor 202.

The category of the area in the direction of travel of the autonomous working apparatus 100 includes a first area having a gradient within a preset range. Optionally, the gradient range is 20-70 degrees. Optionally, the gradient range is 25-60 degrees. Optionally, the gradient range is 25-55 degrees. The category of the area in the direction of travel of the autonomous working apparatus 100 further includes a second area having a grass height within a preset height range.

S400: Generate at least one instruction associated with the first sensor according to the category.

Optionally, in view of a first area having a gradient within a preset range, the processor is configured to generate an instruction for reducing a detection distance of the first sensor 201 when determining that the area in the direction of travel of the autonomous working apparatus 100 is the first area.

Optionally, in view of the first area having the gradient within the preset range, the processor 30 is configured to generate an instruction for turning off the first sensor 201 when determining that the area in the direction of travel of the autonomous working apparatus 100 is the foregoing first area.

Optionally, in view of the first area having the gradient within the preset range, the processor 30 is configured to generate an instruction for filtering the surrounding environment data of the autonomous working apparatus 100 obtained by the first sensor 201 when determining that the area in the direction of travel of the autonomous working apparatus 100 is the foregoing first area. Optionally, the second sensor 202 is configured to obtain the surrounding environment data of the autonomous working apparatus 100. The processor 30 is further configured to determine whether an obstacle surrounds the autonomous working apparatus 100 based on fusion of data input by the first sensor 201 and the second sensor 202. The processor 30 is configured to generate an instruction for reducing a fusion ratio of the surrounding environment data of the autonomous working apparatus obtained by the first sensor 201 when determining that the area in the direction of travel of the autonomous working apparatus 100 is the first area.

Related details are described with reference to the foregoing embodiments of the autonomous working apparatus 100.

To sum up, according to the control method for the autonomous working apparatus provided in this embodiment, a category of an area in a direction of travel of the autonomous working apparatus 100 is determined based on data of the second sensor 202, and the processor 30 generates a instruction associated with the first sensor 201 according to the category. The problem that the first sensor 201 (such as an ultrasonic sensor) executes an obstacle avoidance action upon mistaken detection of a slope as an obstacle and thus cannot move forward up the slope is at least solved. Therefore, the autonomous working apparatus of this application may normally execute the obstacle avoidance action without affecting a climbing function and a mowing task of the autonomous working apparatus.

FIG. 4 is a block diagram of a processor 30 according to an embodiment of this application. The processor 30 includes at least a processor and a memory 303. Optionally, the processor includes at least a first processor 301, a second processor 302, and the memory 303. The first processor 301 is configured to load and execute mapping and positioning programs of the autonomous working apparatus 100. The second processor 302 is configured to load and execute a generation program of a instruction of the autonomous working apparatus 100 with respect to the first sensor 201. By providing at least two processors, it is beneficial to balance the computing power, thereby ensuring the smooth operation of the autonomous working apparatus 100.

The first processor 301 and the second processor 302 both includes one or more processing cores, for example, a 4-core processor, an 8-core processor, and the like. The processor 301 is implemented in at least one hardware form of digital signal processing (DSP), a field-programmable gate array (FPGA), and a programmable logic array (PLA). The processor 301 further includes a main processor and a co-processor. The main processor is a processor for processing data in a wake-up state, also referred to as a central processing unit (CPU). The co-processor is a low-power processor for processing data in a standby state. In some embodiments, the first processor 301 and the second processor 302 is integrated with a graphics processing unit (GPU). The GPU is configured to render and draw content that needs to be displayed on a display screen. In some embodiments, the processor 301 further includes an artificial intelligence (AI) processor. The AI processor is configured to process computing operations related to machine learning.

The memory 303 includes one or more computer-readable storage media. The computer-readable storage medium is non-transient. The memory 303 further includes a high-speed random access memory and a nonvolatile memory, for example, one or more disk storage devices or flash storage devices. In some embodiments, the non-transient computer-readable storage medium in the memory 303 is configured to store at least one instruction. The at least one instruction is used to be executed by the first processor 301 and the second processor 302 to implement the control method for the autonomous working apparatus provided in the method embodiments of this application.

In some embodiments, the control apparatus for the autonomous working apparatus further optionally includes: a peripheral interface and at least one peripheral. The processor, the memory 303, and the peripheral interface is connected through a bus or a signal cable. Each peripheral is connected to the peripheral interface through a bus, a signal cable, or a circuit board. Schematically, the peripheral includes, but is not limited to: a cleaning mechanism, a radio frequency circuit, a touch display screen, an audio circuit, a power supply, and the like.

The control apparatus for the autonomous working apparatus, certainly, further includes fewer or more assemblies. This embodiment is not limited thereto.

Optionally, this application further provides a computer-readable storage medium. The computer-readable storage medium stores a computer program. The program is loaded and executed by a processor to implement the control method for the autonomous working apparatus 100 in the method embodiments.

Optionally, this application further provides a computer product. The computer product includes a computer-readable storage medium. The computer-readable storage medium stores a program. The program is loaded and executed by a processor to implement the control method for the autonomous working apparatus 100 in the method embodiments.

The technical features in the foregoing embodiments is randomly combined. For concise description, not all possible combinations of the technical features in the embodiments are described. However, provided that combinations of the technical features do not conflict with each other, the combinations of the technical features are considered as falling within the scope described in this specification.

The foregoing embodiments only describe several implementations of this application, which are described specifically and in detail, but cannot be construed as a limitation to the patent scope of this application. It is to be noted that for a person of ordinary skill in the art, several transformations and improvements is made without departing from the idea of this application. These transformations and improvements belong to the protection scope of this application. Therefore, the protection scope of the patent of this application shall be subject to the appended claims.

1-15. (canceled)

16. An autonomous working apparatus, the autonomous working apparatus comprising:
a mover, configured to drive the autonomous working apparatus to move in a working area;
a sensor, comprising at least a first sensor and a second sensor different from the first sensor, the first sensor being configured to obtain surrounding environment data of the autonomous working apparatus, and the second sensor being configured to obtain the surrounding environment data of the autonomous working apparatus or positioning data of a current position of the autonomous working apparatus; and
a processor, connected at least to the sensor, the processor being configured to determine a category of an area in a direction of travel of the autonomous working apparatus based on a processing result of data input by the second sensor and to generate at least one instruction associated with the first sensor according to the category.

17. The autonomous working apparatus according to claim 16, wherein
the category of the area comprises a first area, the first area is an uphill area having a gradient within a preset range, and the processor is configured to generate an instruction for reducing a detection distance of the first sensor when determining that the area in the direction of travel of the autonomous working apparatus is the first area.

18. The autonomous working apparatus according to claim 16, wherein
the category of the area comprises a first area, the first area is an uphill area having a gradient within a preset range, and the processor is configured to generate an instruction for turning off the first sensor when determining that the area in the direction of travel of the autonomous working apparatus is the first area.

19. The autonomous working apparatus according to claim 16, wherein
the category of the area comprises a first area, the first area is an uphill area having a gradient within a preset range, and the processor is configured to generate a instruction for filtering the surrounding environment data of the autonomous working apparatus obtained by the first sensor when determining that the area in the direction of travel of the autonomous working apparatus is the first area.

20. The autonomous working apparatus according to claim 16, wherein
the second sensor is configured to obtain the surrounding environment data of the autonomous working apparatus;
the processor is further configured to determine whether an obstacle surrounds the autonomous working apparatus based on fusion of data input by the first sensor and the second sensor; and
the category of the area comprises a first area, the first area is an uphill area having a gradient within a preset range, and the processor is configured to generate an instruction for reducing a fusion ratio of the surrounding environment data of the autonomous working apparatus obtained by the first sensor when determining that the area in the direction of travel of the autonomous working apparatus is the first area.

21. The autonomous working apparatus according to claim 16, wherein
The processor is further configured to determine whether there is an obstacle surrounding the autonomous working apparatus based on data input by the first sensor; and
The first sensor is further configured to obtain obstacle data around the autonomous working apparatus;
the category of the area comprises a first area, the first area is an uphill area having a gradient within a preset range, and the processor is configured to generate an instruction for reducing a reaction distance of the first sensor when determining that the area in the direction of travel of the autonomous working apparatus is the first area;
the processor is further configured to determine whether the distance between the autonomous working apparatus and the obstacle is less than or equal to the reaction distance based on data input by the first sensor, and control the autonomous working apparatus to execute an obstacle avoidance action.

22. The autonomous working apparatus according to claim 20, wherein the second sensor comprises at least one of a LIDAR sensor and a vision sensor.

23. The autonomous working apparatus according to claim 16, wherein
the second sensor is configured to obtain positioning data of a current position of the autonomous working apparatus, the positioning data comprising height data of the current position of the autonomous working apparatus; and
the processor is configured to calibrate a position of a first area having a gradient within a preset range in the working area according to the height data of the surface of the working area to draw an area map of the working area before the autonomous working apparatus executes a working task.

24. The autonomous working apparatus according to claim 23, wherein the processor is configured to determine a category of an area in a direction of travel of the autonomous working apparatus based on a processing result of a positioning data of the current position of the autonomous working apparatus and the area map of the working area.

25. The autonomous working apparatus according to claim 16, wherein each first area corresponds to one area identifier;
the second sensor is configured to detect the area identifier;
wherein the processor is configured to determine a category of an area in a direction of travel of the autonomous working apparatus based on detection data of detecting the identifier.

26. The autonomous working apparatus according to claim 16, wherein the processor is further configured to determine whether a distance between the autonomous working apparatus and the first area in the direction of travel is less than or equal to a preset distance, and to generate the at least one instruction if the distance is less than or equal to the preset distance.

27. The autonomous working apparatus according to claim 16, wherein after the autonomous working apparatus leaves the first area for a predetermined distance or a predetermined time, the processor is further configured to stop generating an instruction for reducing a detection distance of the first sensor, or stop generating an instruction for filtering the surrounding environment data of the autonomous working apparatus obtained by the first sensor, or stop generating an instruction for reducing a fusion ratio of the surrounding environment data of the autonomous working apparatus obtained by the first sensor, or stop generating an instruction for reducing a reaction distance.

28. The autonomous working apparatus according to claim 23, wherein the second sensor comprises a satellite positioning sensor.

29. The autonomous working apparatus according to claim 16, wherein the first sensor is configured to transmit a signal around the autonomous working apparatus and receive a reflected signal of the signal, so as to obtain the surrounding environment data of the autonomous working apparatus.

30. The autonomous working apparatus according to claim 29, wherein the first sensor comprises an ultrasonic sensor.

31. The autonomous working apparatus according to claim 30, wherein a detection distance of the ultrasonic sensor is less than or equal to 60 cm.

32. The autonomous working apparatus according to claim 30, wherein a detection distance of the ultrasonic sensor is less than or equal to 38 cm.

33. A control method for an autonomous working apparatus, the autonomous working apparatus comprising a mover, a sensor, and a processor connected at least to the sensor, the sensor assembly comprising at least a first sensor and a second sensor different from the first sensor, the control method comprising:
controlling the first sensor to obtain surrounding environment data of the autonomous working apparatus;
controlling the second sensor to obtain the surrounding environment data of the autonomous working apparatus or positioning data of (at vs of) a current position of the autonomous working apparatus;
determining a category of an area in a direction of travel of the autonomous working apparatus according to a processing result of data input by the second sensor; and
generating at least one instruction associated with the first sensor according to the category.

34. A processor, the processor comprising at least one processor and a storage medium, the memory storing a program loaded and executed by the at least one processor to implement the steps of the control method for the autonomous working apparatus according to claim 33.
